(19) United States
(12) Patent Application Publication
(10) Pub. No.: US 2012/0003507 A1
(43) Pub. Date: Jan. 5, 2012

(54) BATTERY SYSTEM HAVING AN OUTPUT VOLTAGE OF MORE THAN 60 V DIRECT CURRENT VOLTAGE

(76) Inventor: Berengar Krieg, Gerlingen (DE)

(21) Appl. No.: 13/256,145

(22) PCT Filed: Jan. 29, 2010
(86) PCT No.: PCT/EP10/51073

§ 371 Date: Sep. 12, 2011

(30) Foreign Application Priority Data
Mar. 12, 2009 (DE) 10 2009 001 514.0

(51) Int. Cl. H01M 10/42; H01M 6/50; H01M 8/24; H01M 8/04; H01M 6/42; H01M 16/00

(52) U.S. Cl. 429/7; 429/150; 429/452; 429/9

(57) ABSTRACT

The invention relates to a battery system having an output voltage of more than 60 V direct current voltage. In the invention, at least two voltage sources having an output voltage of less than 60 V each, each having at least one contact, via which the at least two voltage sources can be connected in series by at least one conductive connection. A battery housing is provided in which the at least two voltage sources are arranged. According to the invention, at least one reversible, interruptible, conductive connection is functionally designed such that a series circuit of the at least two voltage sources can be created by the conductive connection when the battery housing is closed and upon opening the battery housing, a series circuit of the at least two voltage sources is reversibly interruptible. The invention further relates to a motor vehicle having the battery system.

### PRIOR ART

The handling of assemblies with different voltages is regulated by corresponding standards. The standard ISO 6469 distinguishes between class A for direct current voltages of 0 to 60 V or alternating current voltages of 0 to 25 V at 15 to 150 Hz and class B for direct current voltages greater than 60 V and up to 1500 V or alternating current voltages of greater than 25 V and up to 1000 V at 15 to 150 Hz.

For voltage-carrying components in class B, separate steps must be taken to provide protection in the event of direct contact and defects in insulation.

For voltages in class A, no separate contact protection is required for voltage-carrying parts.

Battery systems, e.g., of the kind used in hybrid vehicles or electric vehicles, frequently have an output voltage >60 V and thus fall under class B of the above-mentioned standard.

This voltage can be achieved using battery systems embodied in the form of series circuits of voltage sources such as battery cells (NiCd, NiMH, Li-ion, or Li-polymer) or capacitors (supercaps, ultracapacitors).

In addition to the voltage sources, the battery systems can also contain control units for battery monitoring and the like. In order to replace or repair these, it may be necessary to open the battery system.

Since the individual cells of the battery should be stored in the partially charged state and the production site of the cells is not necessarily the same as the production site of the battery system, it is not possible to assemble the battery system in a voltage-free state. It is therefore necessary even during the production of the battery system to provide an increased amount of protection from electrical voltages.

The object of the present invention is to reduce or eliminate one or more disadvantages of the above-described prior art.

### DISCLOSURE OF THE INVENTION

The object is attained by creating a battery system having an output voltage of more than 60 V of direct current voltage, having

a) at least two voltage sources, each with an output voltage of less than 60 V and each with at least one contact via which the voltage sources can be connected in series by means of reversibly interruptible conductive connections;

b) a battery housing in which the at least two voltage sources are accommodated;

c) at least one reversibly interruptible conductive connection, which is functionally embodied so that the conductive connection is able to produce a series circuit of the at least two voltage sources when the battery housing is closed and a series circuit of the at least two voltage sources can be reversibly interrupted when the battery housing is opened.

The embodiment according to the invention is based on the idea of embodying the series circuit of voltage sources in a battery system so that the series circuit is reversibly and where appropriate mechanically interrupted when the housing of the battery system is opened, e.g. for maintenance work, and during the production process, the series circuit is only completed once the battery system is closed.

This makes it unnecessary to provide special protective clothing and specially insulated tools for maintenance and assembly personnel. It also drastically reduces the risk of injury due to contact with high electrical voltages.

The battery system according to the invention has an output voltage of more than 60 V of direct current voltage and can essentially be used to supply any type of electrical consumer that requires a supply of electrical energy at such an output voltage.

To achieve the desired output voltage of the battery system, the battery system contains a plurality of voltage sources that are connected in series during operation of the battery system. The battery system according to the invention includes at least two voltage sources, each with an output voltage of less than 60 V and each with at least one contact via which the at least two voltage sources can be connected in series by means of at least one conductive connection. In this case, one voltage source can contain one or more battery cells or capacitors, for example supercapacitors and/or ultracapacitors. The term battery cell is understood here to mean any electrochemical energy storage device that stores energy by means of electrochemical processes. In particular, these include accumulator and battery cells of the following types. Preferred electrochemical energy storage devices include fuel cells, in particular of the following types: alkaline fuel cells (AFC), polymer electrolyte fuel cells (PEMFC), direct methanol fuel cells (DMFC), phosphoric acid fuel cells (PAFC), molten carbonate fuel cells (MCFC), and/or solid oxide fuel cells (SOFC). Other preferred electrochemical energy storage devices are accumulators, in particular of the following types: Ph—lead accumulators, NiCd—nickel-cadmium accumulators, NiH2—nickel-hydrogen accumulators, NiMH—nickel-metal hydride accumulators, Li-ion—lithium-ion accumulators, LiPo—lithium polymer accumulators, LiFe—lithium-metal accumulators, Li—Mn—lithium-manganese accumulators, LiFePO₄—lithium-iron phosphate accumulators, LiTi—lithium-titanate accumulators, RAM—rechargeable alkaline manganese accumulators, Ni—Fe—nickel-iron accumulators, Na/NiCl—sodium-nickel chloride high-temperature batteries, SCiB—super-charging ion batteries, silver-zinc accumulators, silicon accumulators, vanadium redox accumulators, and/or zinc-bromine accumulators.

Voltage sources with an output voltage of less than 60 V are used as the voltage sources. In this case, a voltage source can have one or more battery cells. If a voltage source contains a plurality of battery cells, then these are connected in series during operation of the battery system. In particular, a voltage source can include more than one cell of one battery type.

The battery system according to the invention can have more than two voltage sources, each with an output voltage of less than 60 V. In this case, the voltage sources in the battery system are functionally situated so that the voltage sources can be connected in series by means of reversibly interruptible conductive connections. If the individual voltage sources produce a voltage of less than an nth part of 60 V in the fully charged state, then it is possible for series circuits of up to n voltage sources to remain when the battery housing is open. When the housing is opened, it is possible for every connection between the individual voltage sources to be interrupted or for only selected connections between them to be interrupted.

The battery system according to the invention has a battery housing in which the at least two voltage sources are accommodated. Preferably, the battery housing encloses all voltage sources of the battery system and when closed, insulates them from the surroundings. The voltage sources of the battery system are positioned inside the battery housing and when the housing is closed, are connected in series with one another. The battery housing has contacts that are accessible from outside and are embodied as connectable to a consumer so that the electrical energy of the output voltage of the battery system can be supplied to the consumer by means of them. In particular, the battery housing of the battery system according to the invention is embodied so that the series circuit of voltage sources is reversibly interruptible by means of at least one conductive connection before the battery housing is opened far enough to permit an object (e.g. a screwdriver) to be inserted into the interior of the battery housing. To that end, the battery housing can have openable and/or removable parts that functionally and/or mechanically contact a conductive connection directly or indirectly in such a way that a series circuit of voltage sources is reversibly interrupted before the housing part is opened and/or removed. The battery housing can be composed of multiple parts and can have an openable cover. In particular an openable cover of the battery housing can be provided with a device that ensures that at least one conductive connection is connected to the cover. The cover and in particular the device of the cover for connecting the cover to the conductive connection can be embodied so that when the cover is opened, the at least one conductive connection can reversibly interrupt the series circuit of voltage sources.

The voltage sources can be situated in one or more levels in the battery housing. In particular, the voltage sources can be situated in at least two levels in the battery housing; at least one level has more than one voltage source.

In addition to the voltage sources, the battery housing can also have or contain additional devices such as control units for battery monitoring and the like.

The battery system according to the invention has at least one conductive connection that is functionally embodied so that the reversibly interruptible conductive connection can produce a series circuit of the at least two voltage sources when the battery housing is closed and a series circuit of the at least two voltage sources can be reversibly interrupted when the battery housing is opened. If the voltage sources in the battery housing are situated in at least two levels, with at least one level having more than one voltage source, then the voltage sources of the at least two levels can be connected in series by means of at least one reversibly interruptible conductive connection and the at least one reversibly interruptible conductive connection between the at least two levels can be simultaneously equipped with a reversibly interruptible conductive connection between the voltage sources of one level, preferably the level situated closest to a cover of the battery housing.

A conductive connection can in particular be embodied as reversibly interruptible by virtue of the fact that the connection is automatically interrupted when the battery housing is opened.

For example, this can be achieved by embodying the reversibly interruptible conductive connection in the form of a plug connection, with at least one part of the plug connection being functionally connected to a housing part of the battery system in such a way that the plug connection is disconnected when the battery housing is opened. For example, the reversibly interruptible conductive connection can be embodied in the form of a plug connection in which either the “male” contact or blade is mounted on the voltage source itself (or at the end of the series circuit of less than 60 V) and the “female” connector is slid onto it when the housing is closed, or the “female” connector is mounted on the voltage source and the “blade” is connected to a part that moves when the housing is opened. Preferably, one part of the plug connection is connected to an openable and/or removable cover of the battery housing.

The reversibly interruptible conductive connection can also be embodied in the form of a press connection. One example of this is a connection that, with the fixed assembly of housing halves (e.g. by means of screws), can be pressed against the poles/contacts of the voltage sources and when the housing is opened, e.g. when the screw connection is disconnected, can be moved away from the poles/contacts of the voltage sources.

The reversibly interruptible conductive connection can also be embodied in the form of a screw connection. For example, the poles/contacts of the voltage sources can be embodied in the form of threaded rods and a battery housing part can contain an arrangement that includes

i) a conductive connection,

ii) a nut, and

iii) an insulating and optionally sealed mount for the nut by means of which the nut can be turned.

Preferably, the battery system according to the invention has at least one reversibly interruptible conductive connection that is embodied in the form of a plug connection, a press connection, or a screw connection.

The present invention also includes an electrical consumer that contains a battery system according to the invention. The important thing is not that the consumer and battery system constitute one structural unit, but that the consumer and battery system according to the invention are functionally in contact so that the battery system can supply the consumer with electrical energy. In particular, the consumer can be a motor vehicle. The term “motor vehicle” should be understood here to mean all driven vehicles that have an electrochemical energy storage device with an output voltage of more than 60 V, independent of what type of drive these motor vehicles have. In particular, the term “motor vehicle” includes HEVs (hybrid electric vehicles), PHEVs (plug-in hybrid vehicles), EVs (electric vehicles), fuel cell vehicles, and any vehicle that uses an electrochemical energy storage device for the electrical energy supply.

### DRAWINGS

FIG. 1 shows an embodiment of the battery system according to the invention, with a closed battery housing; between the two outermost poles/contacts of the voltage sources, there is a voltage >60 V; this voltage must be conveyed out of the housing in a suitable way.

FIG. 2 shows an embodiment of the battery system according to the invention, with a partially opened housing; the series circuit of greater than 60 V has already been separated into circuits of less than 60 V; the interior of the housing is not yet accessible.

FIG. 3 shows an embodiment of the battery system according to the invention, with the housing completely opened; the interior is accessible and all voltages that can be touched are less than 60 V.

FIG. 4 shows another embodiment of the battery system according to the invention, embodied in the form of a two-layer system, when the housing is closed; the high voltage is accessible between the outermost right contact of the upper layer and the outermost right contact of the lower layer and must be conveyed out of the housing in a suitable way; the connection between the layers connects the contacts on the left.

FIG. 5 shows another embodiment of the battery system according to the invention, embodied in the form of a two-layer system; when the housing is opened, this disconnects the connections of the first layer and the contact to the layer beneath it.

FIG. 6 shows another embodiment of the battery system according to the invention, embodied in the form of a two-layer system; when the housing is opened, the connections of the first layer and the contact to the layer beneath it are disconnected; when the first layer is removed, exposing the lower layer, this disconnects the connections of the lower layer.

FIG. 7 shows an embodiment of the reversibly interruptible conductive connection in the form of a press connection.

FIG. 8 shows another embodiment of the reversibly interruptible conductive connection in the form of a screw connection.

### DESCRIPTION OF SELECTED EMBODIMENTS OF THE INVENTION

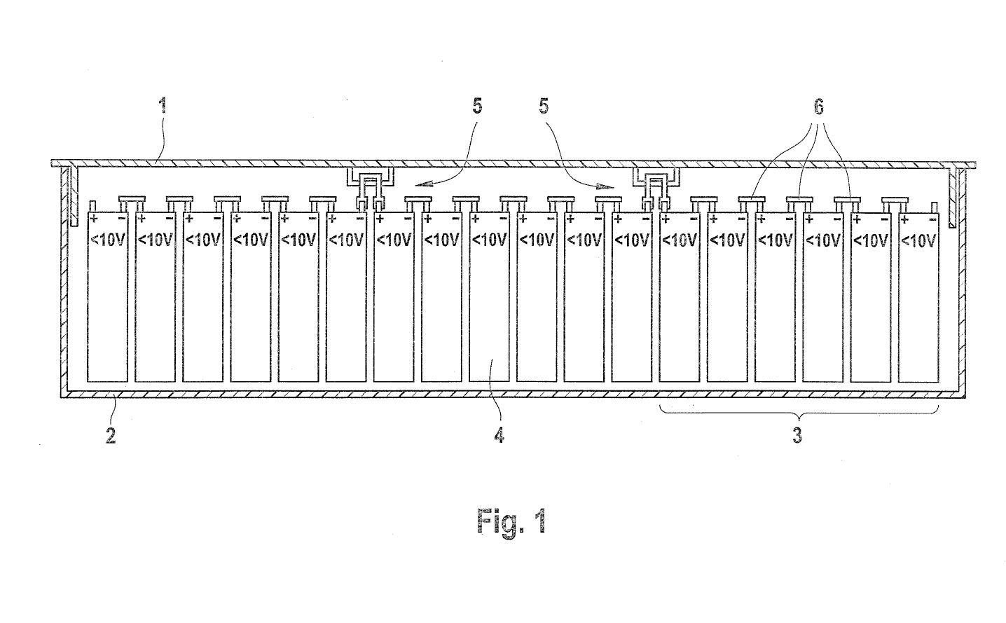

FIG. 1 schematically depicts an embodiment of the battery system according to the invention. The battery system has an at least two-part battery housing, with a lower housing part 2, which accommodates the voltage sources 3, and a housing cover 1. The battery system is depicted in the closed state; the cover 1, which is insulated or is itself electrically nonconductive, rests on the lower housing part 2. Three voltage sources 3 are situated in the lower housing part 2; each of the three voltage sources 3 has six respective battery cells 4. Each of the battery cells 4 has an output voltage of less than 10 V in the fully charged state. The six battery cells 4 of a voltage source 3 are already connected in series. The three voltage sources 3 are respectively connected in series with one another via two reversibly interruptible conductive connections 5. The two reversibly interruptible conductive connections 5 here are embodied as plug connections (with the “male” part of the plug connection being situated on the current source) and are fastened to the housing cover 1.

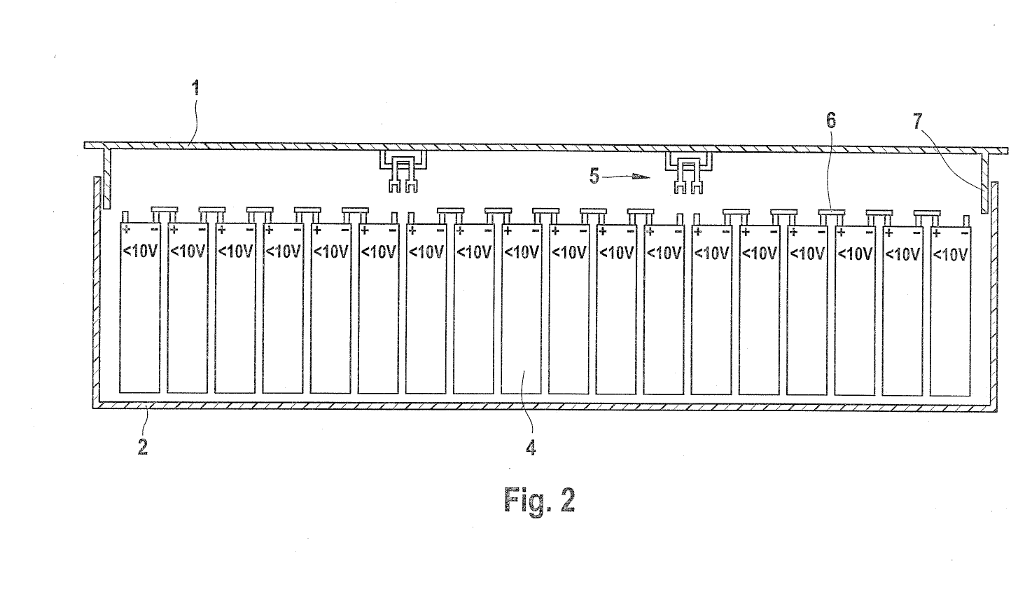

If the cover 1 is then lifted from the lower housing part 2, as shown in FIG. 2, this interrupts the reversibly interruptible conductive connection 5 in that the connecting piece fastened to the cover 1 is moved upward and the “male” part is pulled out from the “female” part of the plug connection. This interrupts the series circuit of voltage sources 3, leaving three isolated voltage sources 3, each of which has an output voltage of less than 60 V. In this case, the cover 1 is embodied so that the reversibly interruptible conductive connections 5 are interrupted in a housing position in which objects are still prevented from being inserted into the housing interior. To accomplish this, the cover 1 can, for example, be equipped with lateral skirts 7 extending around the edge of the cover, which are dimensioned so that an object can be inserted into the housing only after the conductive connections 5 have been interrupted.

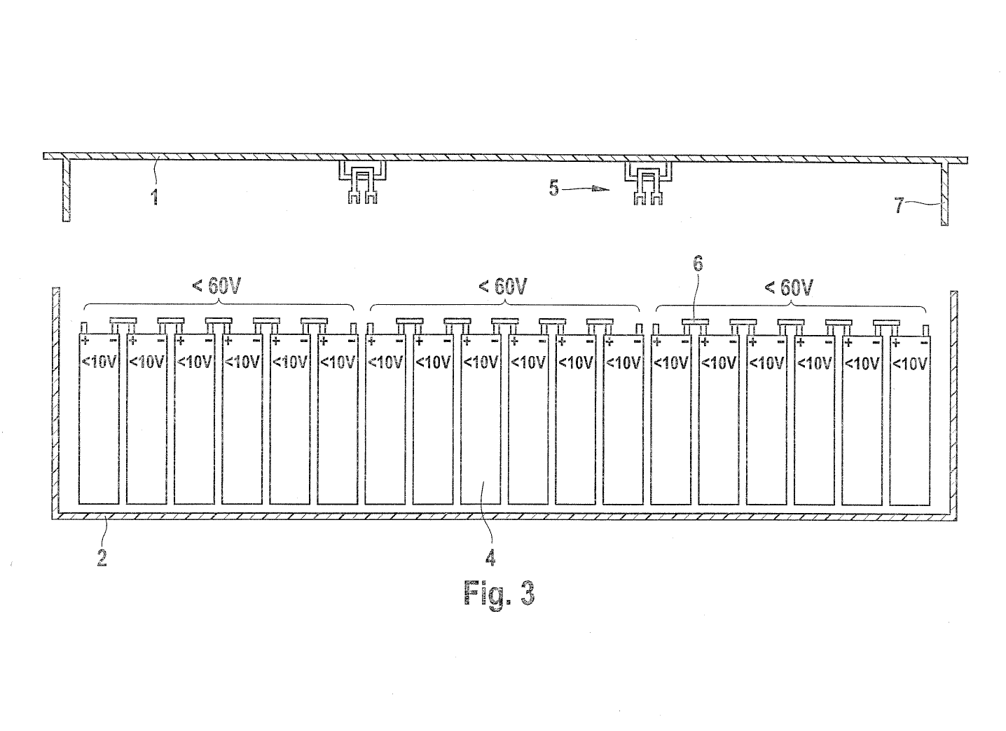

Only after the housing has been completely opened, as shown in FIG. 3, is it possible to also access the housing interior; the reversibly interruptible conductive connections 5 remain interrupted in this case. In the lower housing part 2, there are now no longer any touchable parts that can transmit a voltage of more than 60 V. Maintenance work on the battery system can now be safely carried out.

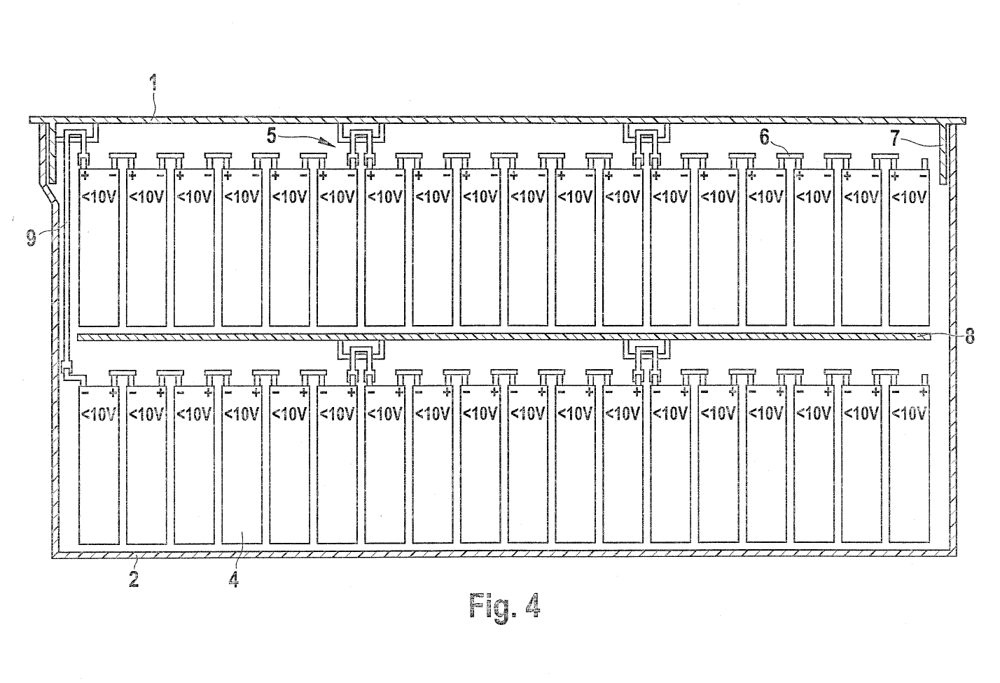

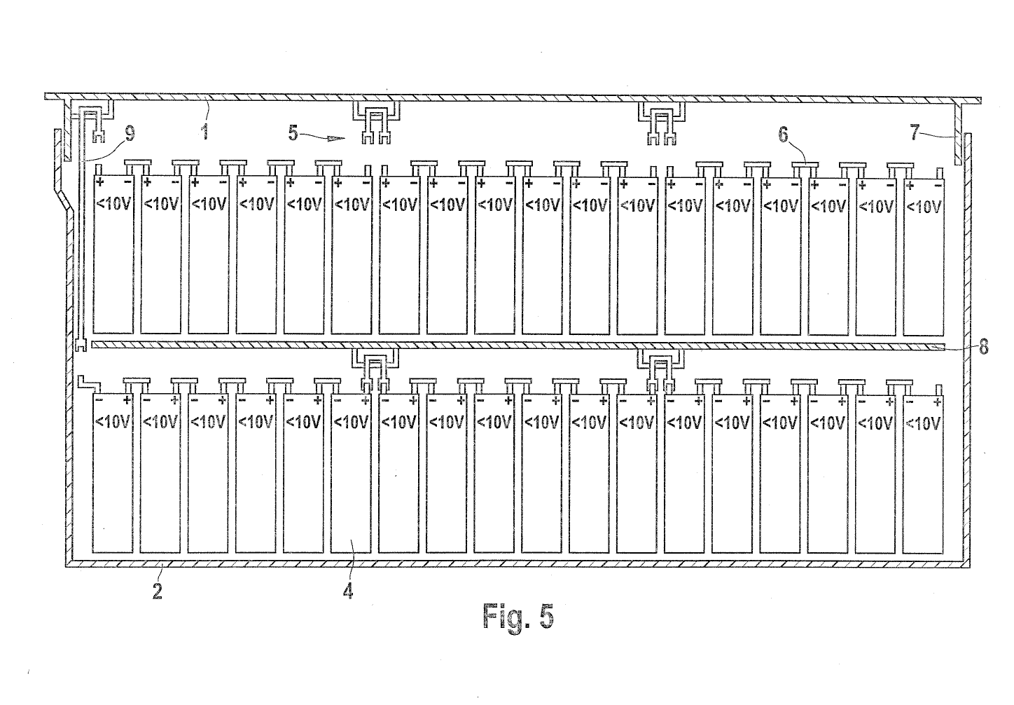

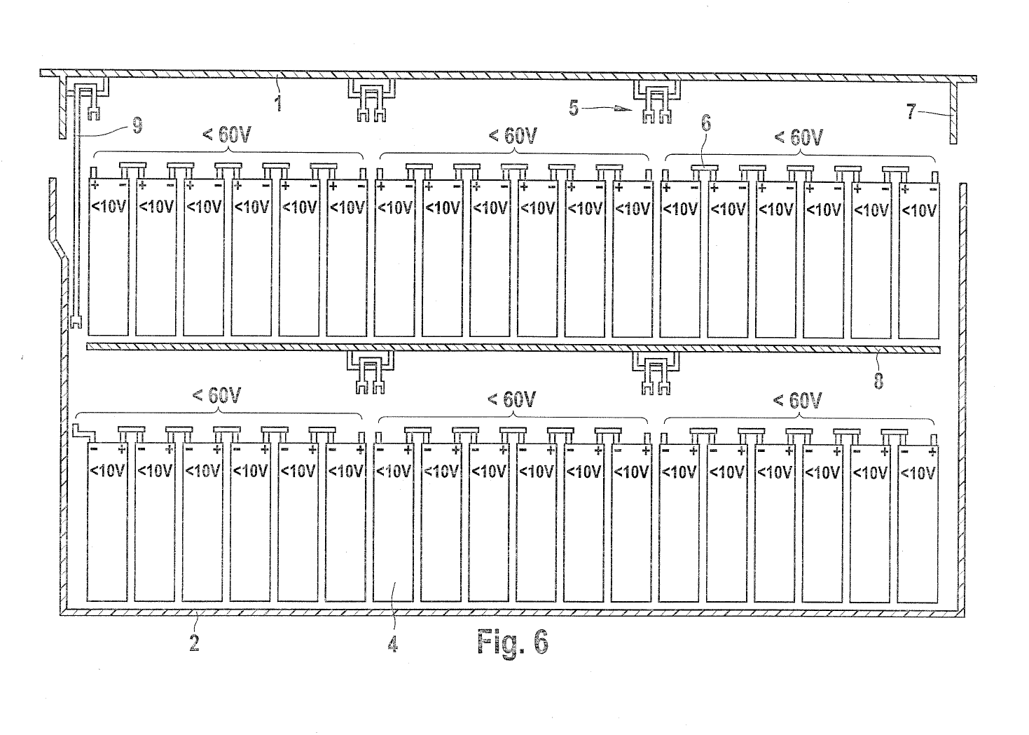

FIG. 4 schematically depicts another embodiment of the battery system according to the invention in which the battery system has voltage sources 3 in two levels. The description below will focus essentially on the differences between the embodiment in FIGS. 1 through 3 and the embodiment in FIGS. 4 through 6. When the battery housing is closed, all of the voltage sources 3 of the battery system are connected in series with one another. Reversibly interruptible conductive connections 5 are fastened to the cover 1 as well as to the intermediate floor 8 of the battery system. If the housing cover 1 is then lifted as shown in FIG. 5, then this disconnects the reversibly interruptible conductive connections 5 between the voltage sources 3 of the first level and also disconnects the reversibly interruptible conductive connection 9 that connects the two levels. At first, the voltage sources 3 of the lower level remain connected in a series circuit. But when the intermediate floor 8 of the battery system is lifted as shown in FIG. 6, this also interrupts the reversibly interruptible conductive connections 5 of the lower level. There are now no longer any touchable parts that can transmit a voltage of more than 60 V. Maintenance work on the battery system can now be safely carried out.

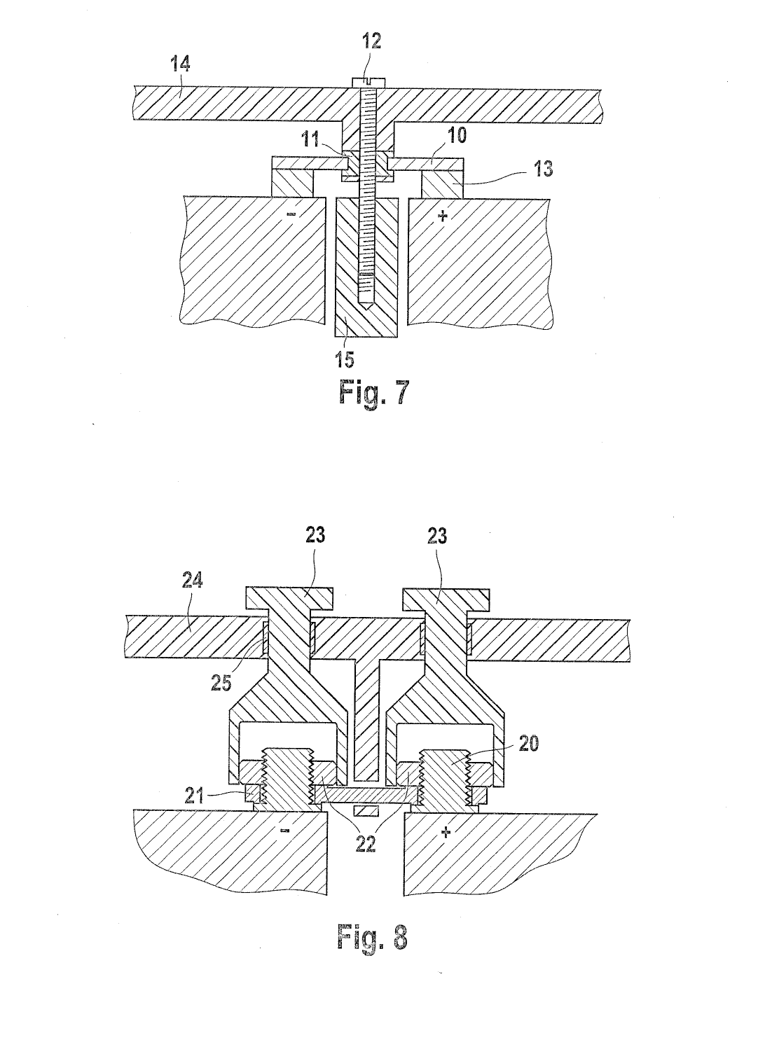

FIG. 7 shows a possible embodiment of a reversibly interruptible conductive connection in the form of a press connection. In this case, an insulated screw connection (depicted as 11, 12, 14, 15) presses the conductive connector 10 against the poles/contacts 13 of the voltage sources to be connected in series, thus connecting them conductively. If the insulated screw connection (depicted as 11, 12, 14, 15) is disconnected, then this disconnects the contact between the conductive connector 10 and the poles/contacts 13 of the voltage sources and thus reversibly interrupts the conductive connection.

FIG. 8 shows one possible embodiment of a reversibly interruptible conductive connection in the form of a screw connection. In this case, the poles/contacts 20 of the voltage sources to be connected are embodied in the form of threaded rods. The conductive connector 21 is brought into contact with the poles 20 and fixed in place by means of threaded nuts 22. The threaded nuts 22 are embodied so that they can be rotated from the outside the housing by means of nut holders. Disconnecting the threaded nuts 22 interrupts the reversibly interruptible conductive connection; tightening the threaded nuts 22 produces the connection again.

1-10. (canceled)

11. A battery system with an output voltage of more than 60 V of direct current voltage, comprising:
at least two voltage sources, each with an output voltage of less than 60 V and each with at least one contact via which it is possible to connect the voltage sources in series by means of reversibly interruptible conductive connections;
a battery housing in which the at least two voltage sources are accommodated; and
at least one reversibly interruptible conductive connection, which is functionally embodied so that the conductive connection is able to produce a series circuit of the at least two voltage sources when the battery housing is closed and so that it is possible to reversibly interrupt a series circuit of the at least two voltage sources when the battery housing is opened.

12. The battery system according to claim 11, wherein at least one of the voltage sources with an output voltage of less than 60 V has multiple cells of one battery type, with the cells of a voltage source being connected in series.

13. The battery system according to claim 11, wherein the battery system has more than two voltage sources, each with an output voltage of less than 60 V, which are functionally situated so that it is possible to connect the voltage sources in series by means of reversibly interruptible conductive connections.

14. The battery system according to claim 12, wherein the battery system has more than two voltage sources, each with an output voltage of less than 60 V, which are functionally situated so that it is possible to connect the voltage sources in series by means of reversibly interruptible conductive connections.

15. The battery system according to claim 11, wherein the voltage sources are situated in at least two levels in the battery housing and at least one level has more than one voltage source.

16. The battery system according to claim 12, wherein the voltage sources are situated in at least two levels in the battery housing and at least one level has more than one voltage source.

17. The battery system according to claim 13, wherein the voltage sources are situated in at least two levels in the battery housing and at least one level has more than one voltage source.

18. The battery system according to claim 14, wherein the voltage sources are situated in at least two levels in the battery housing and at least one level has more than one voltage source.

19. The battery system according to claim 15, wherein it is possible for the voltage sources of the at least two levels to be connected in series by means of at least one reversibly interruptible conductive connection and the at least one reversibly interruptible conductive connection between the at least two levels is simultaneously equipped in a reversibly interruptible way with a reversibly interruptible conductive connection between the voltage sources of one level.

20. The battery system according to claim 16, wherein it is possible for the voltage sources of the at least two levels to be connected in series by means of at least one reversibly interruptible conductive connection and the at least one reversibly interruptible conductive connection between the at least two levels is simultaneously equipped in a reversibly interruptible way with a reversibly interruptible conductive connection between the voltage sources of one level.

21. The battery system according to claim 17, wherein it is possible for the voltage sources of the at least two levels to be connected in series by means of at least one reversibly interruptible conductive connection and the at least one reversibly interruptible conductive connection between the at least two levels is simultaneously equipped in a reversibly interruptible way with a reversibly interruptible conductive connection between the voltage sources of one level.

22. The battery system according to claim 18, wherein it is possible for the voltage sources of the at least two levels to be connected in series by means of at least one reversibly interruptible conductive connection and the at least one reversibly interruptible conductive connection between the at least two levels is simultaneously equipped in a reversibly interruptible way with a reversibly interruptible conductive connection between the voltage sources of one level.

23. The battery system according to claim 11, wherein the battery housing is functionally embodied so that it is possible to reversibly interrupt the series circuit of voltage sources by means of at least one reversibly interruptible conductive connection before the battery housing is opened far enough to permit an object to be inserted into the battery housing interior.

24. The battery system according to claim 22, wherein the battery housing is functionally embodied so that it is possible to reversibly interrupt the series circuit of voltage sources by means of at least one reversibly interruptible conductive connection before the battery housing is opened far enough to permit an object to be inserted into the battery housing interior.

25. The battery system according to claim 11, wherein the battery housing is composed of at least two parts and an openable cover; at least one reversibly interruptible conductive connection is connected to the cover so that when the cover is opened, it is possible to reversibly interrupt the series circuit of voltage sources by means of the at least one reversibly interruptible conductive connection.

26. The battery system according to claim 24, wherein the battery housing is composed of at least two parts and an openable cover; at least one reversibly interruptible conductive connection is connected to the cover so that when the cover is opened, it is possible to reversibly interrupt the series circuit of voltage sources by means of the at least one reversibly interruptible conductive connection.

27. The battery system according to claim 11, wherein at least one reversibly interruptible conductive connection is embodied as a plug connection, press connection, or screw connection.

28. The battery system according to claim 26, wherein at least one reversibly interruptible conductive connection is embodied as a plug connection, press connection, or screw connection.

29. A consumer containing a battery system according to one claim 1.

30. The consumer according to claim 29, wherein the consumer is a motor vehicle.
